(19) United States
(12) Patent Application Publication
(10) Pub. No.: US 2017/0305049 A1
(43) Pub. Date: Oct. 26, 2017

(54) METHOD OF PRODUCING TOPPING HANGER

(71) Applicant: Jia-Hua CAO, Shangrao (CN)

(72) Inventor: Jia-Hua CAO, Shangrao (CN)

(21) Appl. No.: 15/136,879

(22) Filed: Apr. 23, 2016

(51) Int. Cl. B29C 45/16; B29C 45/00; B29B 7/00; B29B 13/06; B65B 63/08; B29L 31/00

(52) U.S. Cl. CPC B29C 45/1679; B29B 13/06; B29C 45/0053; B65B 63/08; B29B 7/00; B29C 2045/0096; B29K 2995/0026; B29L 2031/735; B29K 2995/0021

(57) ABSTRACT

The present invention provides a method of producing a topping hanger comprising: (a) inspecting raw materials; (b) calculating a formula; (c) mixing uniformly; (d) dehumidifying the raw materials; (e) injection molding a colored mixed body: introducing the dehumidified raw materials into an injection molding machine at temperature 200-350° C., and the colored mixed body being produced by injecting molding after adjusting parameters of molds; (f) injection molding a transparent exterior body: a transparent PET and acrylics being formed of the transparent exterior body outside of the colored mixed body by injection molding at temperature 200-350° C.; and (g) packing the products. The transparent exterior body fully coats with the colored mixed body via injection molding, and this feature effectively enhances quality and visual effect, and chemical and color stability of the products, and reduces the cost. The present invention reduces damage during objects with colors contacting human.

### BACKGROUND OF THE INVENTION

### 1. Field of the Invention

The present disclosure relates to a method of producing a hanger. In particular, it relates to a method of producing a topping hanger.

### 2. Description of the Related Art

A hanger is usually used for holding clothes. Recently, the hanger is usually made of plastic material, and the plastic hanger would be manufactured easily and is cost-efficient, light, convenient to carry, and has variety of colors. However, the method of producing current plastic hanger consumes lots of raw materials, the objects with colors are harmful for human body, pollute the air and water resource easily, unfriendly with the environment, and lack visual and artistic effect. The appearance and firmness are also not good for the current hanger. Therefore, the current hanger has to be improved.

### SUMMARY OF THE INVENTION

The main purpose is to provide a method of producing a topping hanger to improve the conventional technology, solve above-mentioned problems, and enhance application widely for industry.

To achieve above-mentioned objective, the present invention provides a method of producing a topping hanger comprising: (a) inspecting raw materials: using an inspection machine to inspect physical and chemical features of the raw materials, sampling and inspecting color and water of the raw materials and comparing with standard raw materials, wherein only raw materials with parameters meet all standards deliver to a warehouse; (b) calculating a formula: according to demanding parameters of products, the most reasonable formula is calculated by an allocating machine, wherein the raw materials comprise ABS, PC, TPR, PET, talcum powders, and acrylics, and the raw materials are drew out form the warehouse and then put into a stirring machine; (c) mixing uniformly: starting the stirring machine and stirring the raw materials in constant speed until the raw materials are fully mixed, the raw materials are introduced into a drying machine after mixing uniformly; (d) dehumidifying the raw materials: drying the mixed raw materials by the drying machine; (e) injection molding a colored mixed body: introducing the dehumidified raw materials into an injection molding machine at temperature 200-350° C., and the colored mixed body are produced by injecting molding after adjusting parameters of molds; (f) injection molding a transparent exterior body: a transparent PET and acrylics are formed of the transparent exterior body outside of the colored mixed body by injection molding at temperature 200-350° C., wherein the transparent exterior body fully coats with the colored mixed body to form the products; and (g) packing the products: the products are packed automatically by a packing machine.

Preferably, the stirring speed of step (c) is 100-120 rpm.

Preferably, the drying temperature of step (d) is 100-120° C.

The present invention has significant advantages and effects. In particular, the transparent exterior body fully coats with the colored mixed body via injection molding. The quality and visual effect of products are enhanced, and the cost is reduced. The chemical and color stability of products are excellent. The present invention can reduce damage during the objects with colors contacting human body. The products are automatically produced by machine, so that the present invention can reduce the workforce, increase efficiency, productivity, and profit. Therefore, the present invention can be widely applied.

Many of the attendant features and advantages of the present invention will becomes better understood with reference to the following detailed description considered in connection with the accompanying drawings.

### BRIEF DESCRIPTION OF THE DRAWINGS

The detailed structure, operating principle and effects of the present invention will now be described in more details hereinafter with reference to the accompanying drawings that show various embodiments of the present invention as follows.

FIG. 1 is a flow diagram of the preferable embodiment in the present invention.

### DETAILED DESCRIPTION OF THE PREFERRED EMBODIMENTS

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Various embodiments will now be described more fully with reference to the accompanying drawings, in which illustrative embodiments are shown. The inventive concept, however, may be embodied in various different forms, and should not be construed as being limited only to the illustrated embodiments. Rather, these embodiments are provided as examples, to convey the inventive concept to one skilled in the art. Accordingly, known processes, elements, and techniques are not described with respect to some of the embodiments.

For convenience, certain terms employed in the specification, examples and appended claims are collected here. Unless defined otherwise, all technical and scientific terms used herein have the same meaning as commonly understood by one of the ordinary skill in the art to which this invention belongs.

The singular forms “a”, “and”, and “the” are used herein to include plural referents unless the context clearly dictates otherwise.

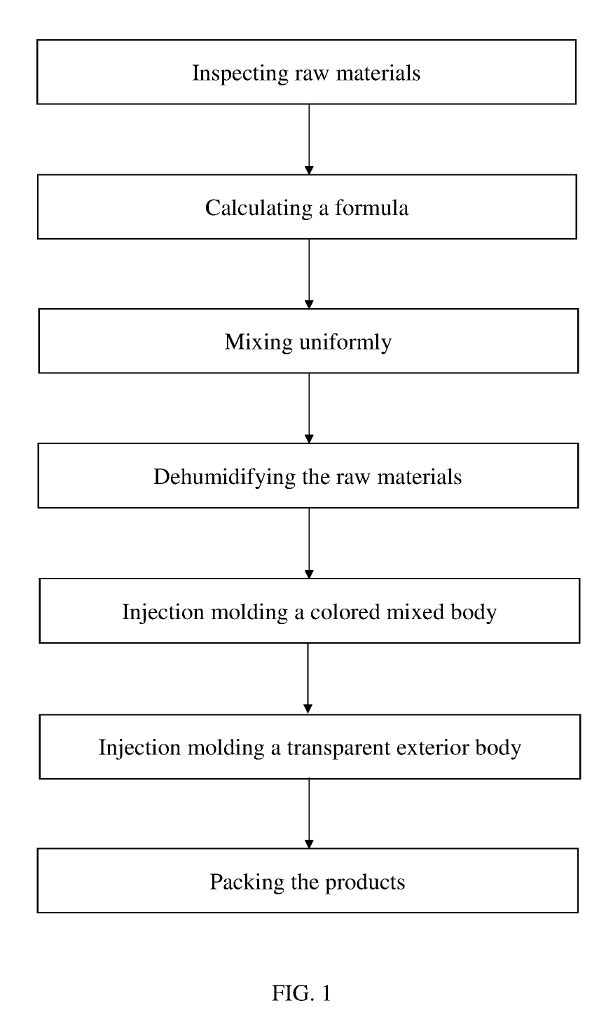

Please refer to FIG. 1, the present invention provides a method of producing a topping hanger comprising: (a) inspecting raw materials: using an inspection machine to inspect physical and chemical features of the raw materials, sampling and inspecting color and water of the raw materials and comparing with standard raw materials, wherein only raw materials with parameters meet all standards deliver to a warehouse; (b) calculating a formula: according to demanding parameters of products, the most reasonable formula is calculated by an allocating machine, wherein the raw materials comprise ABS, PC, TPR, PET, talcum powders, and acrylics, the raw materials are drew out form the warehouse and then put into a stirring machine; (c) mixing uniformly: starting the stirring machine and stirring the raw materials in constant speed until the raw materials are fully mixed, the raw materials are introduced into a drying machine after mixing uniformly; (d) dehumidifying the raw materials: drying the mixed raw materials by the drying machine; (e) injection molding a colored mixed body: introducing the dehumidified raw materials into an injection molding machine at temperature 200-350° C., and the colored mixed body is produced by injecting molding after adjusting parameters of molds; (f) injection molding a transparent exterior body: a transparent PET and acrylics are formed of the transparent exterior body outside of the colored mixed body by injection molding at temperature 200-350° C., wherein the transparent exterior body fully coats with the colored mixed body to form the products; and (g) packing the products: the products are packed automatically by a packing machine.

The most important features of the present invention is that the transparent exterior body fully coats with the colored mixed body via injection molding, and this feature effectively enhances quality and visual effect of the products, chemical and color stability of the products, and reduces the cost. The present invention can reduce damage during the objects with colors contacting human body. The products are automatically produced by machine, so that the present invention can reduce the workforce, increase efficiency, productivity, and profit.

The above-mentioned descriptions represent merely the exemplary embodiment of the present invention, without any intention to limit the scope of the present disclosure thereto. Various equivalent changes, alternations or modifications based on the claims of present invention are all consequently viewed as being embraced by the scope of the present invention.

It will be understood that the above description of embodiments is given by way of example only and that various modifications may be made by those with ordinary skill in the art. The above specification, examples, and data provide a complete description of the present invention and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. A method of producing a topping hanger, comprising:
(a) inspecting raw materials: using an inspection machine to inspect physical and chemical features of the raw materials, sampling and inspecting color and water of the raw materials and comparing with standard raw materials, wherein only raw materials with parameters meet all standards deliver to a warehouse;
(b) calculating a formula: according to demanding parameters of products, the most reasonable formula being calculated by an allocating machine, wherein the raw materials comprise ABS, PC, TPR, PET, talcum powders, and acrylics, the raw materials are drew out form the warehouse and then put into a stirring machine;
(c) mixing uniformly: starting the stirring machine and stirring the raw materials in constant speed until the raw materials being fully mixed, the raw materials being introduced into a drying machine after mixing uniformly;
(d) dehumidifying the raw materials: drying the mixed raw materials by the drying machine;
(e) injection molding a colored mixed body: introducing the dehumidified raw materials into an injection molding machine at temperature 200-350° C., and the colored mixed body being produced by injecting molding after adjusting parameters of molds;
(f) injection molding a transparent exterior body: a transparent PET and acrylics being formed of the transparent exterior body outside of the colored mixed body by injection molding at temperature 200-350° C., wherein the transparent exterior body fully coats with the colored mixed body to form the products; and
(g) packing the products: the products being packed automatically by a packing machine.

2. The method as defined in claim 1, wherein the stirring speed of step (c) is 100-120 rpm.

3. The method as defined in claim 1, wherein the drying temperature of step (d) is 100-120° C.
